(19) United States
(12) Patent Application Publication
(10) Pub. No.: US 2019/0172457 A1
(43) Pub. Date: Jun. 6, 2019

(54) NOTEBOOK COMPUTER AND DRIVING METHOD OF VOICE ASSISTANT SYSTEM

(71) Applicants: Yu-Wen Cheng, Taipei City (TW); Wang-Hung Yeh, Taipei City (TW); Hsin-Chieh Fang, Taipei City (TW); Shu-Hsien Chu, Taipei City (TW); Chun-Wen Wang, Taipei City (TW)

(72) Inventors: Yu-Wen Cheng, Taipei City (TW); Wang-Hung Yeh, Taipei City (TW); Hsin-Chieh Fang, Taipei City (TW); Shu-Hsien Chu, Taipei City (TW); Chun-Wen Wang, Taipei City (TW)

(73) Assignee: COMPAL ELECTRONICS, INC., Taipei City (TW)

(21) Appl. No.: 16/205,185

(22) Filed: Nov. 29, 2018

Related U.S. Application Data
(60) Provisional application No. 62/593,208, filed on Nov. 30, 2017.

(51) Int. Cl. G10L 15/22; G10L 15/08; G06F 1/16; G06F 1/26

(52) U.S. Cl. CPC G10L 15/22; G10L 15/08; G10L 2015/088; G06F 1/26; G10L 2015/223; G06F 1/1616

(57) ABSTRACT

A notebook computer including a foldable body, a display unit, a touch pad, a keyboard, a first control unit, a wake-up unit, and a voice-assistant system, a second control unit electrically connected to the first control unit, the wake-up unit, and the voice-assistant system is provided. The first control unit is electrically connected to the display unit, the touch pad, and the keyboard. When the foldable body is in a folded and closed state, the display unit, the touch pad, and the keyboard are inactivated, the notebook computer is in a first mode. In the first mode, a user drives the wake-up unit to generate a wake-up signal being transmitted to the second control unit to activate the first control unit and the voice-assistant system. The notebook computer is transformed to a second mode, wherein the display unit, the touch pad, and the keyboard are still inactivated or sleeping.

### CROSS-REFERENCE TO RELATED APPLICATION

This application claims the priority benefit of U.S. provisional application Ser. No. 62/593,208, filed on Nov. 30, 2017. The entirety of the above-mentioned patent application is hereby incorporated by reference herein and made a part of this specification.

### BACKGROUND

### Field of the Invention

The invention relates to a notebook computer and driving method of voice-assistant system.

### Description of Related Art

With the development of electronic device technology, a variety of electronic devices enters users' life. At the same time, since the development of voice recognition technology, a user further controls an electronic device through voice, or has voice interaction with the electronic devices, which brings great convenience to life. Take a notebook computer as an example. With the additional voice assistant function, functionality is improved and the operation experience is optimized.

However, several power states to control power consumption are generally included when the operating system of the notebook computer performs power management. These power states usually include a normal operating mode and a sleep mode that consumes less power. Meanwhile, with sleeping, the body of the notebook computer is returned to the folded and inactivated by the user at this period.

As such, when the notebook computer is inactivated or the aforementioned sleep mode, a voice-assistant function is needed to be performed, the user still needs to extend the body of the notebook computer first, and the power button is thus applied to be reactivated or awakened. Simultaneously, it is also necessary to wait for all the electronic units to be activated before the above voice assistant function may be operated, which is time consuming and fails to meet the convenience of smart electronic devices.

### SUMMARY

The invention provides a notebook computer, performing related functions of a voice-assistant system under the condition that the body of it is in a folded and closed state and the related input and display electronic units are still being inactivated.

The notebook computer of the invention includes a foldable body and a display unit, a touch pad, a keyboard, a first control unit, a second control unit, a wake-up unit, and a voice-assistant system disposed in the foldable body. The first control unit is electrically connected to the display unit, the touch pad, and the keyboard. The wake-up unit is electrically connected to the second control unit, and the second control unit is electrically connected to the first control unit. When the foldable body is folded and closed, the display unit, the touch pad and the keyboard are in a power-off state or a sleep state, so that the notebook computer is in a first mode. In the first mode, a user drives the wake-up unit to generate a wake-up signal being transmitted to the second control unit, so that the second control unit activates the voice-assistant system and the first control unit. The notebook computer is transformed to a second mode, wherein the display unit, the touch pad, and the keyboard are still in the power-off state or the sleep state.

A driving method of voice-assistant system of the invention is provided suitable for a notebook computer. The notebook computer includes the foldable body and the display unit, the touch pad, the keyboard, the first control unit, the second control unit, the wake-up unit and the voice-assistant system disposed in foldable body. The display unit, the touch pad, and the keyboard are electrically connected to the first control unit respectively. The wake-up unit, and the voice-assistant system are electrically connected to the second control unit respectively, and the first control unit is electrically connected to the second control unit. The driving method of voice-assistant system includes: when the foldable body is folded and closed, the display unit, the touch pad, and the keyboard are in a power-off state or a sleep state, so that the notebook computer is in the first mode. In the first mode, an external trigger is provided to the wake-up unit, and the wake-up unit generates and transmits the wake-up signal to the second control unit. In addition, after the wake-up signal is received by the second control unit, the voice-assistant system and the first control unit are activated, so that the notebook computer is transformed to the second mode, and the display unit, the touch pad and the keyboard are still in the power-off state or the sleep state.

Based on the above, the wake-up unit is disposed in the foldable body of the notebook computer. Therefore, when the foldable body is folded and closed, and the display unit, the touch pad and the keyboard are all in the first mode of being inactivated or sleeping, the user drives the wake-up unit to generate a wake-up signal being transmitted to the second control unit, so that the second control unit activates the first control unit and the voice-assistant system, and the notebook computer thus is transformed to the second mode. Furthermore, under the second mode, the display unit, the touch pad, and the keyboard are still being inactivated or sleeping.

As such, there is no need for the user to refold the foldable body, and there is no need to wait for all the electronic units of the notebook computer to be activated before using the voice-assistant system. In terms of the notebook computer, by the first and the second control units corresponding to different electronic units, the main functions and additional functions of the notebook are differentiated. That is, when merely additional features, such as the voice assistant system, are applied, the corresponding electronic unit may be activated by the second control system, or parts of the required electronic units of the first control unit may be activated. The time and power spent on overall activation are saved. According to this, better user experiences are provided to the user through the notebook computer by smarter control methods.

To provide a further understanding of the aforementioned and other features and advantages of the disclosure, exemplary embodiments, together with the reference drawings, are described in detail below.

### BRIEF DESCRIPTION OF THE DRAWINGS

FIG. 1 is a schematic view of a notebook computer in accordance with an embodiment of the invention.

FIG. 2 is a top view of the notebook computer of FIG. 1 in another state.

FIG. 3 is an electrical diagram of the relevant electronic units in a notebook computer.

FIG. 4A is a partial side view of the notebook computer of FIG. 2.

FIG. 4B is a partial side view of a notebook computer of another embodiment of the invention.

FIG. 5A is a flow chart configured to activate a voice assistant system of a notebook computer.

FIG. 5B illustrates the suborder process of the step S02 of FIG. 5A.

FIG. 5C illustrates a flow chart of a voice assistant system in accordance with another embodiment of the invention.

FIG. 6 illustrates an electrical diagram of a notebook computer in another embodiment of the invention.

### DESCRIPTION OF THE EMBODIMENTS

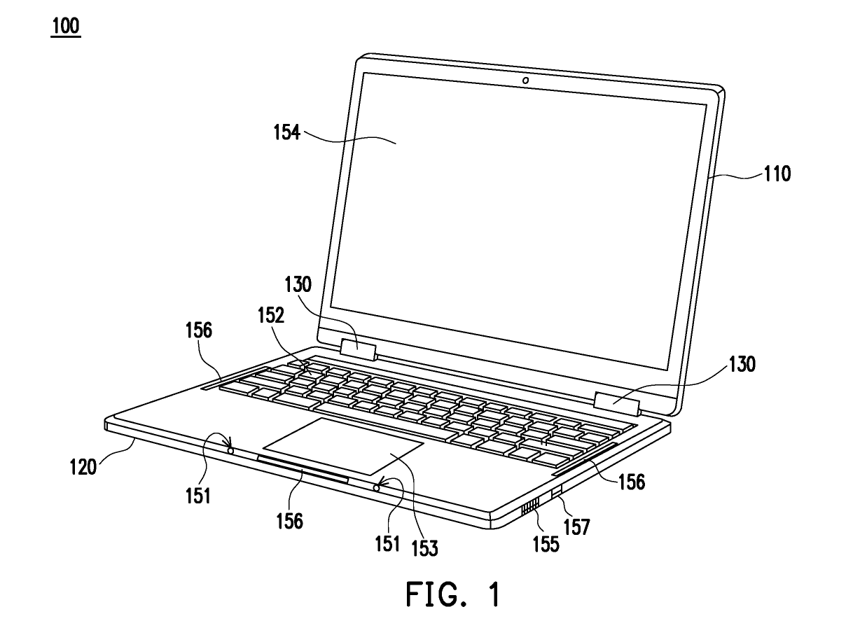

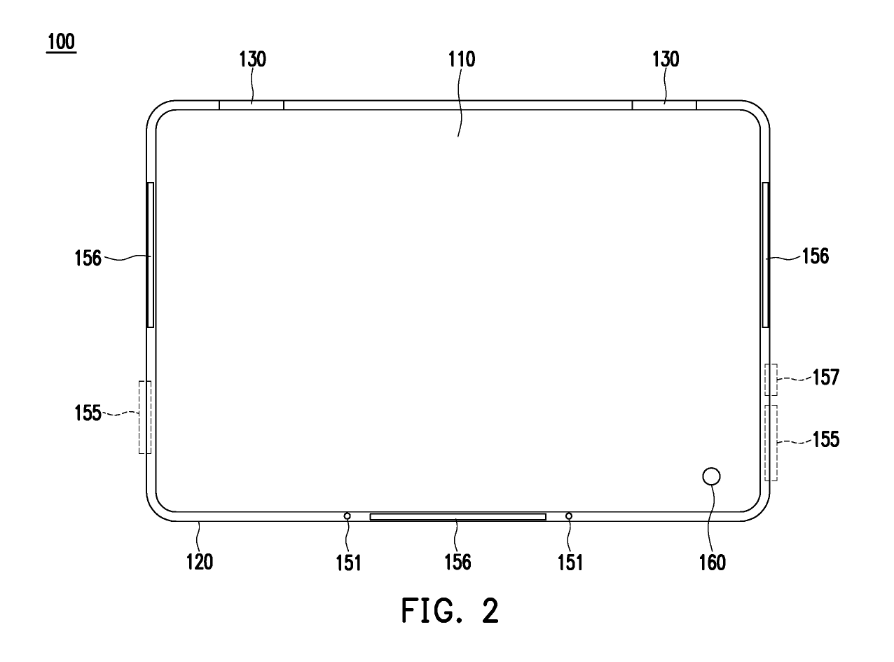

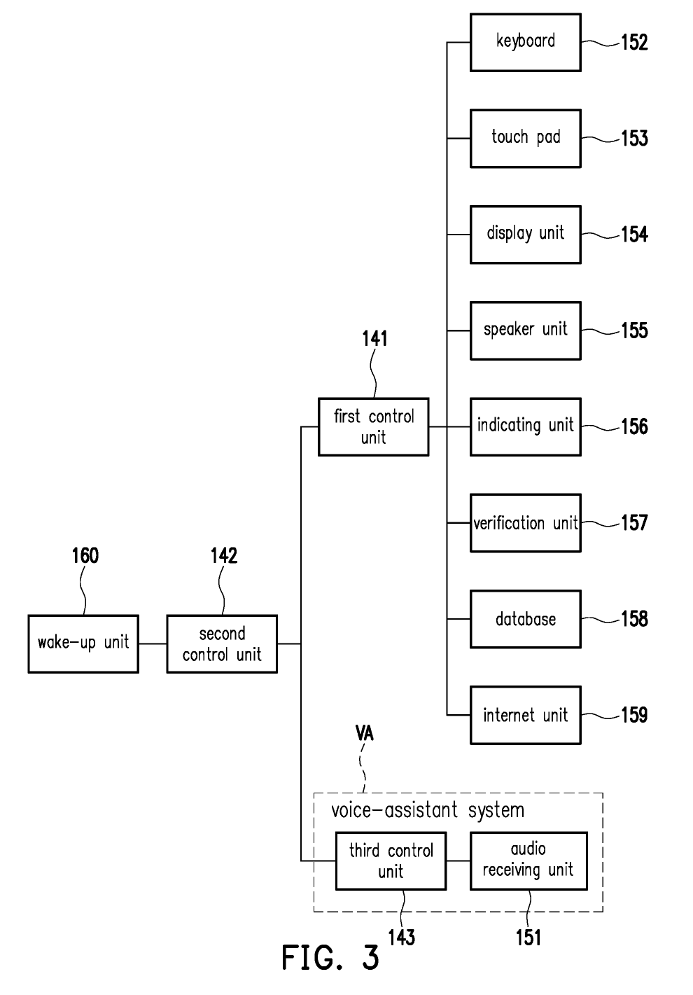

FIG. 1 is a schematic view of a notebook computer in accordance with an embodiment of the invention. FIG. 2 is a top view of the notebook computer of FIG. 1 in another state. FIG. 3 is an electrical diagram of the relevant electronic units in a notebook computer. Please refer to FIG. 1 to FIG. 3 at the same time. In this embodiment, a notebook computer 100 includes a foldable body and a display unit 154, a touch pad 153, a keyboard 152, a first control unit 141, a second control unit 142, a wake-up unit 160, and a voice-assistant system VA disposed in the foldable body. Here, the foldable body includes a first body 110, a second body 120, and a hinge 130 connected therebetween, so that the first body 110 and the second body 120 may be rotated to be folded or unfolded by the hinge 130. FIG. 1 illustrates the expanded (unfolded) foldable body. FIG. 2 illustrates the folded and closed foldable body.

Furthermore, the display unit 154 of this embodiment (for example, a liquid display panel or a touch display panel) is disposed in the first body 110, and the touch pad 153, the keyboard 152 are disposed in the second body 120. At the same time, the notebook computer 100 further includes speaker units 155 (for example, a speaker), indicating units 156 (for example, a LED), a verification unit 157 (for example, a fingerprint recognition), and audio receiving units 151 (for example, a microphone), respectively disposed in the second body 120. In addition, when the first body 110 and the second body 120 are folded and closed, they (the audio receiving units 151, the speaker units 155, the indicating units 156, and the verification unit 157) are exposed outside of the foldable body of the notebook computer 100.

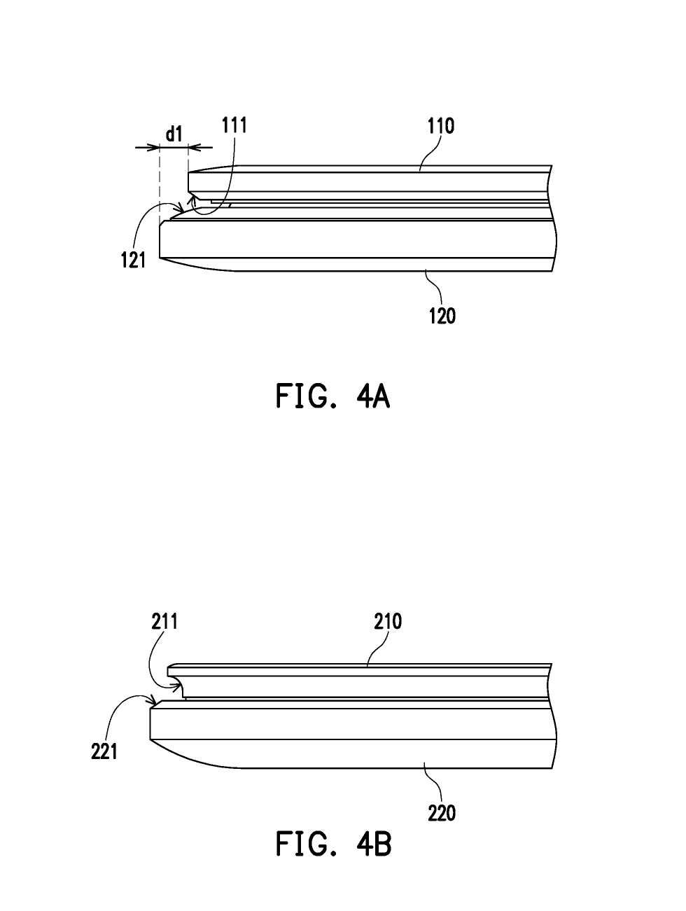

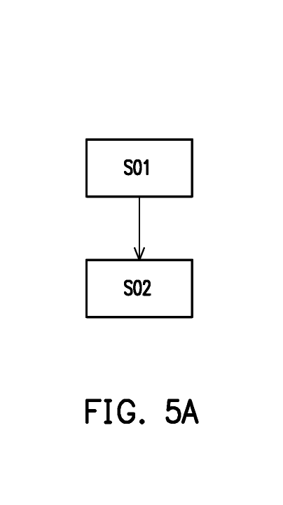

FIG. 4A is a partial side view of the notebook computer of FIG. 2. Please refer to FIG. 1, FIG. 2, and FIG. 4A. In this embodiment, when the first body 110 and the second body 120 are folded, the first body 110 is a retracted structure relative to the second body 120. A side edge of the first body 110 is retracted by a distance dl from a side edge of the second body 120. That is, at this time, an orthographic projection area of the first body 110 onto the second body 120 is smaller than the second body 120. Compared FIG. 2 and FIG. 4A, it is acquired that under the configuration layout, the audio receiving units 151, the speaker units 155, the indicating units 156, and the verification unit 157 are exposed outside of the foldable body, even when the foldable body is folded and closed.

Besides, as illustrated in FIG. 4A, the first body 110 of the notebook computer 100 further has a first indentation 111, and the second body 120 has a second indentation 121, which are, for example, chamfered structures respectively disposed at sides of the foldable body. Chamfering degrees of the second indentation 121 is obviously greater than chamfering degrees of the first indentation 111. Here, aside from configuring the first indentation 111 and the second indentation 121 to the aforementioned retracted structures to provide the configuration of the related electronic units (the audio receiving unit 151 and the indicating unit 156), the user may drive the first body 110 (or the second body 120) to rotate to be folded or unfolded by part of fingers extending into and pressing against the first indentation 111 and the second indentation 121.

FIG. 4B is a partial side view of a notebook computer of another embodiment of the invention. Please refer to FIG. 4B, which is similar to FIG. 4A. A first body 210 is a retracted structure relative to a second body 220. Additionally, the first body 210 has a first indentation 211, a second body 220 has a second indentation 221. The same effects as the above embodiments are thus achieved.

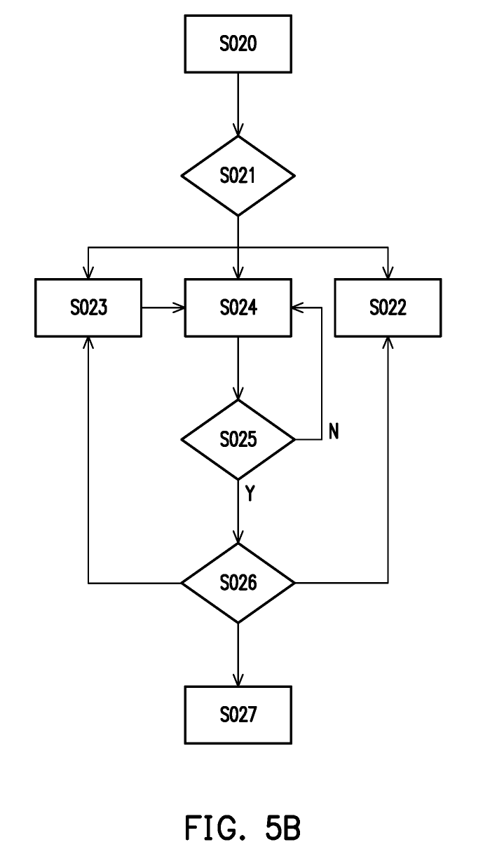

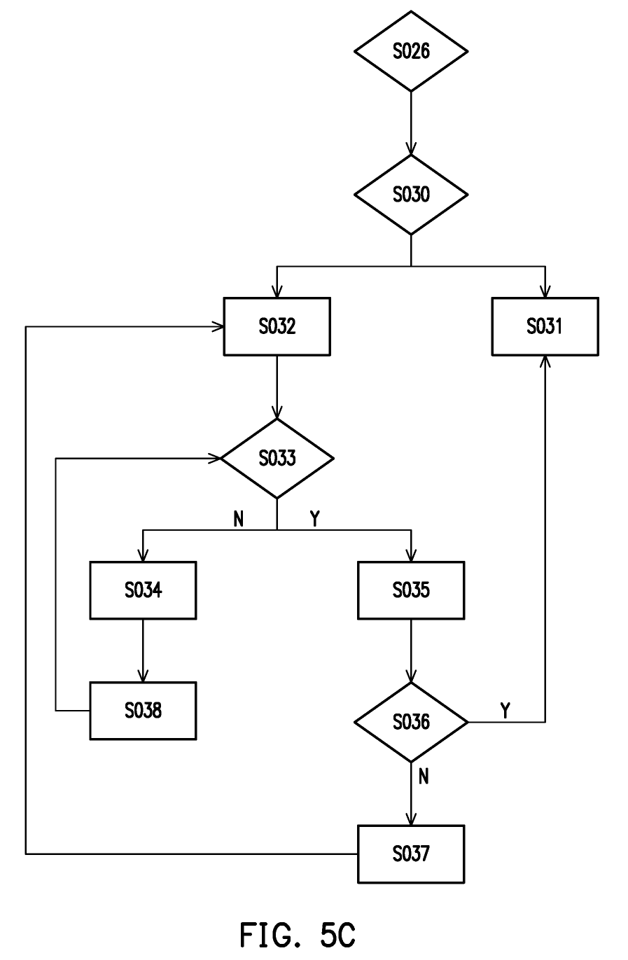

FIG. 5A is a flow chart configured to activate a voice-assistant system of a notebook computer. Please refer to FIG. 2, FIG. 3, and FIG. 5A. In this embodiment, the first control unit 141 is, for example, a central processor of the notebook computer 100, configured to generate a core function of the notebook computer 100. The first control unit 141 is electrically connected to the keyboard 152, the touch pad 153, the display unit 154, the speaker unit 155, the indicating unit 156, and the verification unit 157. The voice-assistant system VA includes a third control unit 143 and the audio receiving unit 151 electrically connected to each other. The second control unit 142 is electrically connected to the first control unit 141, the third control unit 143, and the wake-up unit 160.

Moreover, the wake-up unit 160 is, for example, a physical switch disposed on the first body 110 opposite to the display unit 154. Therefore, when the first body 110 and the second body 120 are folded, the wake-up unit 160 is still exposed outside of the foldable body of the notebook computer 100 for easier user operation. Indeed, the location of the wake-up unit 160 is not limited thereto. As long as one satisfies that the wake-up unit 160 is exposed outside for the user while the body of the notebook computer 100 being folded and closed could be applied to this embodiment.

In this embodiment, the indicating unit 156 is configured to generate different light signals, and the indicating units 156 are disposed at three sides of the second body 120. In addition, when the body is folded and closed, the indicating unit 156 is exposed outside because of the aforementioned retracted structure. In this way, the user acquires the current state of the notebook computer 100 without being affected by the folded and closed body, which is similar to the aforementioned wake-up unit 160. Anything that allows the indicating unit 156 to be visually recognized when the notebook computer 100 is folded and closed could be applied to be disposed as the configuration of the indicating unit 156. Here, the indicating unit 156 is not only directly exposed to the outside of the notebook computer 100, but also allows to be structurally shaded or partially shaded. However, the visual effect it generates can still be exposed outside through the open space of the structure to be perceived by the user. Furthermore, the indicating unit is not limited to the light signal. In other embodiments, anything that generates a feedback visual signal to be recognized by the user is suitable to be applied to the invention.

On the other hand, the indicating unit 156 generates light signals having different visual effects based on the awakened process of the voice-assistant system VA, applied as a feedback to the user. The user may thus acquire the relevant information in the process of the voice assistant system VA being woken up. Take a light signal one (for example, a red light), a light signal two (for example, an orange light) and a light signal three (for example, a blue light) as examples. The light signal one represents the electronic unit related to the voice assistant system VA in an inoperable state, equivalent to the voice-assistant system VA in the inoperable state, equivalent to the voice-assistant system VA being unawakened. The light signal two represents that in the aforementioned electronic unit related to the voice assistant system VA, parts of the electronic units are operable and parts of the electronic units are inoperable. The light signal three represents the electronic unit related to the voice assistant system VA are all completely operable. However, the light signal is not limited the visual display form of the indicating unit. Simultaneously, the aforementioned light signals not necessarily independent to each other. In another embodiment, at least two kinds of lights may simultaneously exist to increase messages that the indicating unit 156 represents.

In view of the above, the voice-assistant system VA is applied as an additional system of the notebook computer 100, which serves as a means for the user to drive the notebook computer 100 by voice control, and a smart effect of the notebook computer 100 is enhanced accordingly. In the notebook computer 100 of this embodiment, electronic units related to the voice-assistant system VA includes the radio unit 151, the speaker unit 155, and the indicating unit 156. Its corresponding configuration relationship has been illustrated as in FIG. 3. The process of the voice assistant system VA being woken up is illustrated one by one from steps illustrated in FIG. 5A.

First, in a step S01, the foldable body of the notebook computer 100 is folded and closed, as illustrated in FIG. 2. The first body 110 is disposed on the second body 120. At this time, the display unit 154, the keyboard 152, and the touch pad 153 have been inactivated by the first control unit 141, and are inoperable or fail to be operated by the user (the display unit 154, the keyboard 152, and the touch pad 153 are in a power-off state or a sleep state). The state illustrated here is defined as a first mode, which is, for example, sleeping or inactivated state of the notebook computer 100. That is, the display unit 154, the keyboard 152, and the touch pad 153 are powered-off or sleeping. It should be illustrated that, the inactivated state here refers to the state of being shutting of electricity, whereas there is still electricity passing through during the sleep state. However, the sleep state is in a state of low power consumption. Under this state, the first control unit 141 and the third control unit 143 are also inactivated themselves respectively after inactivating the electronic units belonged to the first control unit 141 and the third control unit 143. The solely remaining second control unit 142 is electrically contacted the wake-up unit 160 as a standby or a backup. Indeed, in another embodiment, the second control unit 142 may also be attached to the inactivated wake-up unit 160. That is, the second control unit 142 is activated or inactivated by a state change of the wake-up unit 160 on the circuit configuration.

In the first mode, since the second control unit 142 is not the main central processor of the notebook computer 100, the power consumption of it is far below than that of the first control unit 141. The power saving effect is thus achieved.

Then, a step S02 is performed. Generally, in the first mode, the user drives the wake-up unit 160 to generate a wake-up signal by the wake-up unit 160 to activate the second control unit 142. That is, the user provides an external trigger on the wake-up unit 160. In practical operation, for example, the user presses a physical button disposed on the first body 110 to activate the second control unit 142. However, the form of the physical switch of this embodiment is not limited thereto. Then, the first control unit 141 and the third control unit 143 and the audio receiving unit 151 of the voice-assistant system VA are further activated by the second control unit 142, so that the notebook computer 100 is transformed to the second mode. That is, the voice-assistant system VA is awakened while the foldable body being in a folded state. The voice-assistant system VA performs parts of functions of the notebook computer 100 according to the user's instructions afterwards.

It should be illustrated first that the aforementioned wake-up signal leads the second control unit 142 to only activating the speaker unit 155 related to the voice assistant system VA through the first control unit 141, while the keyboard 152, the touch pad 153 and the display unit 154 are still in the power-off state or the sleep state. In other words, at this time, the notebook computer 100 is still being folded and closed as illustrated in FIG. 2.

FIG. 5B illustrates the suborder process of the step S02 of FIG. 5A. Please refer to FIG. 3 and FIG. 5B. In detail, the step S02 of this embodiment further includes a plurality of sub steps configured to let the user acquire the corresponding message or performing different functions during the awakening process of voice-assistant system VA.

In a sub step S020, when the second control unit 142 is activated, and the first control unit 141 as well as the third control unit 143 are thus activated by the second control unit 142, in a sub step S021, the second control unit 142 determines the speaker unit 155's state through the first control unit 141. Meanwhile, the audio receiving unit 151's state is also determined through the third control unit 143. The second control unit 142 performs subsequent movements through the first control unit 141 or the third control unit 143 based on the determination of relevant conditions. In a sub step S022, when the audio receiving unit 151 is unable to receive an external audio signal, the indicating unit 156 generates the light signal one to inform the user that the voice-assistant system VA is unable to receive the user's voice command at present. In addition, when the speaker unit 155 is unable to generate an audio signal, the indicating unit 156 also generates the light signal one. In other words, in the sub step S022, when one of the aforementioned two conditions being satisfied, the light signal one is generated.

Moreover, in a step S023, when the speaker unit 155 is muted, the indicating unit 156 generates the light signal two to inform the user of the speaker unit 155's current state. At this time, the aforementioned muted could be released by the user, so as to facilitate the subsequent processes of awakening the voice-assistant system VA.

Then, when the determination result of the sub step S021 is not illustrated as the sub step S022, a sub step S024 is performed subsequently. That is, the second control unit 142 drives the audio receiving unit 151 to keep receiving the external audio signal through the third control unit 143.

In view of the above, in a sub step S025, the second control unit 142 determines whether the external audio signal received by the audio receiving unit 151 is a key audio signal through the third control unit 143. When the audio receiving unit 151 receives the key audio signal, a sub step S026 is performed. If not, the process is returned to the sub step S024. That is, the audio receiving unit 151 keeps receiving the external audio signal. In a sub step S026, the second control unit 142 determines the speaker unit 155's state again through the first control unit 141. When the speaker unit 155 is unable to generate an audio signal, the sub step S022 is performed, and the indicating unit 156 generates the light signal one. When the speaker unit 155 is muted, the sub step S023 is performed, and the indicating unit 156 generates the light signal two to inform the user.

In view of the above, when the audio receiving unit 151 receives the key audio signal, and the speaker unit 155 is able to generate the audio signal, a sub step S027 is performed. The speaker unit 155 generates a feedback audio signal, so as to interact with the user. In other words, here, the voice-assistant system VA is regarded as activated. The indicating unit 156 generates the light signal three. The user operates the notebook computer 100 by the voice-assistant system VA.

FIG. 5C illustrates a flow chart of a voice assistant system in accordance with another embodiment of the invention to describe additional functions after the end of the process of FIG. 5B. The aforementioned sub step S026 is continued here, and only the state in which the voice assistant system VA has been activated is described. Please refer to FIG. 3 and FIG. 5C at the same time. In this embodiment, the notebook computer 100 further includes the verification unit 157, a database 158, and an internet unit 159, electrically connected to the first control unit 141 respectively, where the verification unit 157 is, for example, a fingerprint recognition disposed in the second body 120. However, the invention is not limited thereto. In another embodiment, the verification unit may also be replaced by the audio receiving unit. That is, the audio receiving unit receives another key audio provided by the user as the basis for the authority recognition.

Besides, the light signal three further includes different display manners such as state one and state two, and so on. It is differentiated by, for example, different light intensities. For instance, the state one is displayed as the light signal three (blue light) at 100% of light intensity. The state two is displayed as the light signal three (blue light) at 30% of light intensity. When the aforementioned sub step S026 is performed and the voice-assistant system VA is activated, a sub step S030 is thus performed. The second control unit 142 further determines the present state of user's authority. When user obtains the authority, a sub step S031 is performed. The light signal three generated by the indicating unit 156 is displayed as the state one, representing that the user has authority, and can perform all the functions of the notebook computer 100 by the voice-assistant system VA when the foldable body is folded and closed.

Conversely, when the user fails to obtain the authority, a sub step S032 is performed. The light signal three of the indicating unit 156 is displayed as the state two. Meanwhile, the speaker unit 155 generates the feedback audio signal to inform the user of not having authority at present. A step S033 is followed subsequently. The second control unit 142 drives the speaker unit 155 through the first control unit 141 to generate the feedback audio signal to inform the user whether to perform the authority login action. If the user replies an audio signal of negative information, a sub step S034 is performed. The light signal three of the indicating unit 156 is displayed as the state two, representing that the user only performs some functions of the notebook computer 100 through the voice assistant system VA at this time. For instance, through the voice-assistant system VA, the user enables the second control unit 142 to perform common search functions of the internet unit 159 through the first control unit 141, and the search results are provided to the user as feedback audio signals to the user with feedback information. It should be illustrated that when the user changes their mind to enhance the authority, the user provides the key audio signal to the voice-assistant system VA in a sub step S038, and the process is started from the sub step S033.

Please further refer to the sub step S033. If the user replies an audio signal with positive information, a sub step S035 is performed. The speaker unit 155 informs the user to start authority login in the feedback audio signal. In addition, in a sub step S036, the user authority (identity) is recognized by the verification unit 157, and is linked to the database 158 for authority (identity) comparison. If the comparison result is compliant with stored information in the database 158, the sub step S031 is performed. The light signal three generated by the indicating unit 156 is displayed as the state one, and the user performs all functions of the notebook computer 100 by the voice-assistant system VA. For example, apart from performing the search function of the aforementioned internet unit 159, any information inside the notebook computer 100 could be loaded or stored by the first control unit 141. That is, the user accesses all information and function of the notebook computer 100.

Once a comparison result is incompatible, a sub step S037 is performed. The speaker unit 155 provides the feedback audio signal, informing the user that the comparison result is incompatible. Moreover, the sub step S032 is performed subsequently. The light signal three of the indicating unit 156 is displayed as the state two. Then, the following are illustrated as the aforementioned process, and shall not be repeated herein.

Please refer to FIG. 5A to FIG. 5C. Based on the above, the step S02 includes only the process shown in FIG. 5B in one embodiment, and in another embodiment, the process illustrated in FIG. 5C may be further included to further provide functions such as authority recognition, thereby improving the smart effect of the notebook computer 100. It should also be noted that the above-mentioned authority and corresponding functions are appropriately adjusted according to the usage requirements or the use environment of the notebook computer 100.

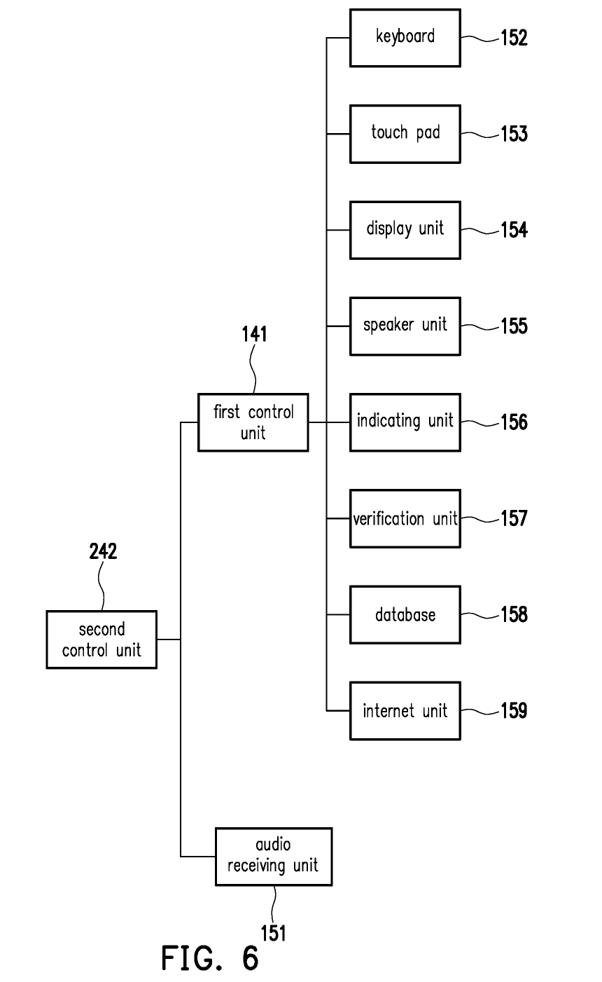

FIG. 6 illustrates an electrical diagram of a notebook computer in another embodiment of the invention to describe the electrical connection between related electronic units. Please refer to FIG. 6. The differences between the aforementioned embodiments and those in this embodiment are that the aforementioned first control unit 141 and the second control unit 142 are integrated as a single second control unit 242, and the second control unit 242 is electrically connected to the first control unit 141 and the audio receiving unit 151 respectively. In addition, the aforementioned physical switch 160 is not disposed in the notebook computer of this embodiment. Instead, the audio receiving unit 151 of this embodiment is used as the wake-up unit 160 in the aforementioned embodiment. That is, the external trigger to the audio receiving unit 151 is provided by the user.

Furthermore, the notebook computer of this embodiment in the aforementioned first mode (the body being folded and closed), the second control unit 242 and the audio receiving unit 151 are operable to determine whether the external audio signal received by the audio receiving unit 151 is the key audio signal. In this way, the wake-up manner applied by the aforementioned user to the physical switch is replaced. Here, the aforementioned process illustrated from FIG. 5A to FIG. 5C may also be applied to this embodiment, and shall not be repeated herein.

In view of the above, in the aforementioned embodiments of the invention, the wake-up unit is disposed in the foldable body of the notebook computer. Therefore, when the foldable body is folded and closed, and the display unit, the touch pad, as well as the keyboard are all in the first mode of being inactivated or sleeping, the user provides the wake-up signal to the second control unit by the wake-up unit, so that the second control unit activates the first control unit and the voice-assistant system. The notebook computer is further transformed to the second mode. In addition, under the second mode, the display unit, the touch pad, and the keyboard are all still in the power-off state or the sleep state. As such, the voice-assistant system could be interacted with the user without opening (expanding) the foldable body again, and there is no need to wait for all the electronic units of the notebook computer to be activated.

The wake-up unit may be the physical switch disposed on the foldable body of the notebook computer as an object to be pressed by the user to perform the wake-up operation. It can also be the audio receiving unit of the notebook computer for continuously collecting and determining the audio signals from the external environment, and generating corresponding actions when receiving the key audio signal. Regardless of the above, the effect of waking up the voice-assistant system may be successfully achieved with specific conditions and processes.

According to this, the notebook computer performs steps of awakening the voice-assistant system under the power-saving condition, and the time and power required to fully activate the electronic unit of the notebook computer are saved. The notebook computer provides the users with better experience through smarter control methods.

Although the invention is disclosed as the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A notebook computer, comprising:
a foldable body;
a display unit, a touch pad, a keyboard, and a first control unit, respectively disposed in the foldable body, the first control unit electrically connected to the display unit, the touch pad and the keyboard;
a second control unit, disposed in the foldable body and electrically connected to the first control unit;
a wake-up unit, disposed in the foldable body, and electrically connected to the second control unit; and
a voice-assistant system, electrically connected to the second control unit,
when the foldable body is in a folded and closed state, and the display unit, the touch pad, and the keyboard are in a power-off state or a sleep state, the notebook computer being in a first mode; in the first mode, an user driving the wake-up unit to generate a wake-up signal being transmitted to the second control unit, so that the second control unit activates the voice-assistant system and the first control unit, thus the notebook computer is transformed to a second mode, wherein the display unit, the touch pad, and the keyboard are still in the power-off state or the sleep state.

2. The notebook computer according to claim 1, wherein the wake-up unit is a physical switch, and when the foldable body is folded and closed, the physical switch is exposed outside of the foldable body,
in the first mode, the second control unit is inactivated, the user drives the wake-up unit to activate the second control unit.

3. The notebook computer according to claim 1, wherein the voice-assistant system comprises an audio receiving unit disposed in the foldable body, electrically connected to the second control unit, the activated second control unit further activates the first control unit and the audio receiving unit.

4. The notebook computer according to claim 3, wherein when the first control unit and the audio receiving unit are activated, the second control unit determines whether an external audio signal received by the audio receiving unit is a key audio signal, and the second control unit drives the first control unit based on the determination of the second control unit.

5. The notebook computer according to claim 4, further comprising an indicating unit, disposed in the foldable body and electrically connected to the first control unit, the indicating unit configured to generate at least one light signal.

6. The notebook computer according to claim 5, wherein the indicating unit is configured to generate a light signal one, a light signal two, or a light signal three,
when the audio receiving unit is unable to receive the external audio signal, the indicating unit generates the light signal one,
when the audio receiving unit receives the external audio signal, but fails to receive the key audio signal, the indicating unit generates the light signal two,
when the audio receiving unit receives the key audio signal, the indicating unit generates the light signal three, the notebook computer is transformed to the second mode.

7. The notebook computer according to claim 6, further comprising a verification unit, disposed in the foldable body and electrically connected to the first control unit, the light signal three further comprising state one and state two, when the notebook computer is transformed to the second mode and the user passes recognition of the verification unit, the light signal three being displayed as the state one, when the notebook computer is transformed to the second mode and the user fails to pass the recognition of the verification unit, the light signal three being displayed as the state two.

8. The notebook computer according to claim 4, further comprising an indicating unit and a speaker unit, respectively disposed in the foldable body and electrically connected to the first control unit, the indicating unit configured to generate a light signal one, a light signal two, or a light signal three,
when the audio receiving unit is unable to receive the external audio signal, the indicating unit generating the light signal one,
when the speaker unit is unable to generate an audio signal, the indicating unit generating the light signal one,
when the audio receiving unit receives the external audio signal but fails to receive the key audio signal, the indicating unit generating the light signal two,
when the audio receiving unit receives the external audio signal and the speaker unit is muted, the indicating unit generating the light signal two,
when the audio receiving unit receives the external audio signal and the speaker unit generates the audio signal, but the audio receiving unit is unable to receive the key audio signal, the indicating unit generating the light signal two,
when the audio receiving unit receives the key audio signal, the second control unit driving the speaker unit by the first control unit to generate a feedback audio signal, and driving the indicating unit to generate the light signal three, the notebook computer being transformed to the second mode.

9. The notebook computer according to claim 8, further comprising a verification unit, disposed in the foldable body and electrically connected to the first control unit, the light signal three further comprising state one and state two, when the notebook computer is transformed to the second mode and the user passes recognition of the verification unit, the light signal three being displayed as the state one, when the notebook computer is transformed to the second mode and the user fails to pass the recognition of the verification unit, the light signal three being displayed as the state two.

10. The notebook computer according to claim 4, further comprising a speaker unit, disposed in the foldable body and electrically connected to the first control unit, when the audio receiving unit receives the key audio signal, the second control unit driving the speaker unit by the first control unit to generate a feedback audio signal.

11. The notebook computer according to claim 4, further comprising an indicating unit, disposed in the foldable body and electrically connected to the first control unit, when the audio receiving unit receives the key audio signal, the second control unit driving the indicating unit by the first control unit to generate a feedback visual signal.

12. The notebook computer according to claim 4, further comprising a verification unit and a database, respectively disposed in the foldable body and electrically connected to the first control unit, the database configured to store a plurality of user authority settings and corresponding user files, the first control unit determining authority of the user by the verification unit and the database, and correspondingly performing different states of use of the second mode.

13. The notebook computer according to claim 4, further comprising an internet unit, disposed in the foldable body and electrically connected to the first control unit, when the audio receiving unit receives the key audio signal, the second control unit driving the internet unit by the first control unit to connect an external internet.

14. The notebook computer according to claim 1, wherein the voice-assistant system comprises a third control unit and an audio receiving unit, the third control unit is electrically connected to the second control unit and the audio receiving unit, when the second control unit activates the voice-assistant system, the second control unit activates the third control unit, and the third control unit activates the audio receiving unit.

15. The notebook computer according to claim 1, wherein the foldable body comprises a first body and a second body pivoted to each other, the display unit is disposed in the first body, the touch pad and the keyboard are disposed in the second body, in the first mode, the first body is folded onto the second body to be closed, and the first body is a retracted structure relative to the second body.

16. The notebook computer according to claim 15, in the first mode, an orthographic projection area of the first body on the second body is smaller than the second body.

17. The notebook computer according to claim 15, further comprising at least one functional unit disposed in the first body or the second body, and being exposed outside the notebook computer in the first mode, the functional unit comprising at least one of an audio receiving unit, an indicating unit, a speaker unit, and a verification unit.

18. The notebook computer according to claim 1, wherein the first mode is a sleep mode of the notebook computer, the second mode is a voice-assistant mode of the notebook computer.

19. A driving method of voice-assistant system, suitable for a notebook computer, the notebook computer comprising a foldable body and a display unit, a touch pad, a keyboard, a first control unit, a second control unit, a wake-up unit and a voice-assistant system disposed in the foldable body, the display unit, the touch pad, and the keyboard electrically connected to the first control unit respectively, the wake-up unit and the voice-assistant system electrically connected to the second control unit respectively, and the first control unit electrically connected to the second control unit, the driving method of voice assistant system comprising:
when the foldable body is folded and closed, the display unit, the touch pad and the keyboard are in a power-off state or a sleep state, so that the notebook computer is in a first mode;
in the first mode, an external trigger provided to the wake-up unit to transmit a wake-up signal to the second control unit; and
the second control unit activating the voice-assistant system and the first control unit after receiving the wake-up signal, so that the notebook computer is transformed to a second mode, and the display unit, the touch pad, and the keyboard are still in the power-off state or the sleep state.

20. The driving method of voice-assistant system according to claim 19, wherein the wake-up unit is a physical switch, and when the foldable body is folded and closed, the physical switch is exposed outside of the foldable body, in the first mode, the second control unit is inactivated, the external trigger is a force being applied to the physical switch.

21. The driving method of voice-assistant system according to claim 19, wherein the voice-assistant system comprises an audio receiving unit disposed in the foldable body, electrically connected to the second control unit, the driving method of voice assistant system further comprises:
the activated second control unit further activating the first control unit and the audio receiving unit.

22. The driving method of voice-assistant system according to claim 21, further comprising:
when the first control unit and the audio receiving unit are activated, the second control unit determining whether an external audio signal received by the audio receiving unit is a key audio signal, and the second control unit driving the first control unit based on the determination.

23. The driving method of voice-assistant system according to claim 22, wherein the notebook computer further comprises an indicating unit, disposed in the foldable body and electrically connected to the first control unit, the indicating unit is configured to generate a light signal one, a light signal two, or a light signal three, the driving method of voice-assistant system further comprises:
when the audio receiving unit is unable to receive the external audio signal, the indicating unit generating the light signal one;
when the audio receiving unit receives the external audio signal, but fails to receive the key audio signal, the indicating unit generating the light signal two;
when the audio receiving unit receives the key audio signal, the indicating unit generates the light signal three, and the notebook computer being transformed to the second mode.

24. The driving method of voice-assistant system according to claim 23, wherein the notebook computer further comprises a verification unit, disposed in the foldable body and electrically connected to the first control unit, and the light signal three comprises state one and state two, the driving method of voice-assistant system further comprises:
when the notebook computer is transformed to the second mode and an user passes recognition of the verification unit, the light signal three being displayed as the state one;
when the notebook computer is transformed to the second mode and the user fails to pass the recognition of the verification unit, the light signal three being displayed as the state two.

25. The driving method of voice-assistant system according to claim 22, wherein the notebook computer further comprises an indicating unit and a speaker unit, respectively disposed in the foldable body and electrically connected to the first control unit, the indicating unit is configured to generate a light signal one, a light signal two or a light signal three, the driving method of voice-assistant system further comprises:
when the audio receiving unit is unable to receive the external audio signal, the indicating unit generating the light signal one;
when the speaker unit is unable to generate an audio signal, the indicating unit generating the light signal one;
when the audio receiving unit receives the external audio signal, but fails to receive the key audio signal, the indicating unit generating the light signal two;
when the audio receiving unit receives the external audio signal, and the speaker unit is muted, the indicating unit generating the light signal two;
when the audio receiving unit receives the external audio signal and the speaker unit generates an audio signal, but the audio receiving unit is unable to receive the key audio signal, the indicating unit generating the light signal two;
when the audio receiving unit receives the key audio signal, the second control unit driving the speaker unit by the first control unit to generate a feedback audio signal, and driving the indicating unit to generate the light signal three, the notebook computer being transformed to the second mode.

26. The driving method of voice-assistant system according to claim 25, wherein the notebook computer further comprises a verification unit, disposed in the foldable body and electrically connected to the first control unit, the light signal three further comprises state one and state two, the driving method of voice-assistant system further comprises:
when the notebook computer is transformed to the second mode and an user passes recognition of the verification unit, the light signal three being displayed as the state one;
when the notebook computer is transformed to the second mode and the user fails to pass the recognition of the verification unit, the light signal three being displayed as the state two.

27. The driving method of voice-assistant system according to claim 22, wherein the notebook computer further comprises a speaker unit, disposed in the foldable body and electrically connected to the first control unit, the riving method of voice-assistant system further comprises:
when the audio receiving unit receives the key audio signal, the second control unit driving the speaker unit by the first control unit to generate a feedback audio signal.

28. The driving method of voice-assistant system according to claim 22, wherein the notebook computer further comprises an indicating unit, disposed in the foldable body and electrically connected to the first control unit, the driving method of voice-assistant system further comprises:
when the audio receiving unit receives the key audio signal, the second control unit driving the indicating unit by the first control unit drive to generate a feedback visual signal.

29. The driving method of voice-assistant system according to claim 22, wherein the notebook computer further comprises a verification unit and a database, respectively disposed in the foldable body and electrically connected to the first control unit, the driving method of voice-assistant system further comprises:
the first control unit determining an user authority by the verification unit and the database, and correspondingly performing different states of use of the second mode.

30. The driving method of voice-assistant system according to claim 22, wherein the notebook computer further comprises an internet unit, disposed in the foldable body and electrically connected to the first control unit, the driving method of voice-assistant system further comprises:
when the audio receiving unit receives the key audio signal, the second control unit driving the internet unit by the first control unit to connect the external internet.

31. The driving method of voice-assistant system according to claim 19, wherein the voice-assistant system comprises a third control unit and an audio receiving unit, the third control unit is electrically connected to the second control unit and the audio receiving unit, the driving method of voice-assistant system further comprises:
when the second control unit activates the voice-assistant system, the second control unit activating the third control unit, and the third control unit activating the audio receiving unit.
